(19) United States
(12) Patent Application Publication
(10) Pub. No.: US 2017/0126327 A1
(43) Pub. Date: May 4, 2017

(54) PRECOMPENSATION TECHNIQUE FOR IMPROVED VCSEL-BASED DATA TRANSMISSION

(71) Applicant: FCI Americas Technology LLC, Carson City, NV (US)

(72) Inventors: Ulrich Dieter Felix Keil, Besancon (FR); Kai Schamuhn, Berlin (DE)

(73) Assignee: FCI Americas Technology LLC, Carson City, NV (US)

(21) Appl. No.: 15/320,179

(22) PCT Filed: Jun. 10, 2015
(86) PCT No.: PCT/US2015/035038

§ 371 Date: Dec. 19, 2016

Related U.S. Application Data
(60) Provisional application No. 62/014,437, filed on Jun. 19, 2014.

(51) Int. Cl. H04B 10/58; H04B 10/50

(52) U.S. Cl. CPC H04B 10/58; H04B 10/503

(57) ABSTRACT

The present disclosure relates to an apparatus for precompensating a VCSEL-signal, comprising a FIR-filter, wherein the FIR-filter is adapted to precompensate a signal by adjusting a portion of the signal in the first bit after a signal transition, and wherein the precompensated signal is injected into a VCSEL.

### TECHNICAL FIELD

The present disclosure relates to the field of optical data transmission via fiber optic systems using vertical-cavity surface-emitting lasers (VCSELs).

### TECHNICAL BACKGROUND

Fiber optic systems allow data transmission at high bit rates over various ranges, from short ranges in the order of few meters to long ranges of many kilometers. As an example, high bit rates over short ranges are required in data centers or similar facilities (e.g., 40 Gigabit/second or 100 Gigabit/second).

For such transmissions, signals representing information bits are usually coupled into the fibers after being emitted by a laser. Lasers used include so-called vertical-cavity surface-emitting lasers (VCSELs), which use a type of semiconductor laser diodes wherein the laser beam is emitted perpendicular to the surface from the top surface of the laser diode. VCSELs are light-emitting devices that are driven by a current. Thus, the VCSEL input signal is a current and the output signal is light.

Various effects distort and degrade the signal. First, depending on the properties of the VCSEL, resonances may occur at higher bandwidths. Second, having coupled the signal into the fiber optics at the transmitter, during propagation through the fiber optics, the signal is subject to various distortions such as optical effects comprising dispersion or complex non-linear effects. There are also other effects which degrade the signal.

After propagating through the fiber optics, the distorted signal is received by a receiver. The receiver has the task of correctly decoding the received signal. However, correctly decoding the signal may be difficult because of the distortion of the signal.

The optical signal is represented as zero “0” (if the power is below a threshold value) or as one “1” (if the power is equal to or above a threshold value).

For determining the quality of the transmitted and received optical signal, it is known to display such signals as so-called eye diagrams. Eye diagrams are a superposition of multiple samples of a signal at different times shifted by a multiple of the data period. In theory, the signal would either be 0 or 1 and the transition between these states would be instantaneous. Therefore, ideally the shape of the signal represented by the eye diagram would be rectangular. However, due to the above mentioned distortions, the shape of the signal is not rectangular but typically resembles the shape of a human eye. Deviations from the ideal shape of an eye indicate disturbances of the signal, e.g., due to bandwidth limitations or resonances in VCSELs. As illustrated by FIG. 1 for a symmetric model, such resonances of VCSELs may (i) lead to an overshoot that violates typical eye masks defined in standards (1), (ii) move the DC level upwards which decreases the sensitivity of receiver circuits particularly in case of asymmetric models, (iii) close the eye on the falling edge (3), and (iv) lead to double traces and thus close the eye horizontally (4).

While FIG. 1 shows an idealized, linear system which is symmetric, realistic systems are non-linear and thus asymmetric. Overshoots and oscillations therefore usually do not cancel out. For instance, overshoots may lead to a wrong (e.g., too high) determination of the DC-signal, i.e., the receiver would determine a wrong decision threshold resulting in a wrong reconstruction of the binary values.

In order to achieve consistent results during data transmission and subsequent signal reconstruction, which are independent of the respective hardware, standards (e.g., defined by IEEE) define specific shapes for the eye diagram, e.g., illustrated in FIG. 2. The areas denoted by 10, 20, and 30 in FIG. 2 define exemplary areas which are to be avoided by the signals in order to allow for a sufficient reconstruction of the signal.

One approach for improving the signal so as to avoid the excluded areas uses a so-called precompensation of the signal. Since the shape of the output signal of the VCSEL is determined by the input current, the precompensation techniques can be applied to the input signal, i.e. the current into the VCSEL. To this end, the signal to be transmitted is adjusted prior to emitting it by the VCSEL and eventually coupling the signal into the fiber.

Several methods for precompensation are known in the art. As an example, it is known to add a short negative or positive signal at the edge of a signal as illustrated by FIGS. 3 and 4. However, research has shown that none of these precompensation techniques can sufficiently compensate for resonances occurring in the VCSELs.

It is therefore desirable to provide an improved precompensation that copes with resonances occurring in VCSELs.

### SUMMARY

In one embodiment, an apparatus is provided for precompensating a VCSEL-signal, the apparatus comprising a FIR-filter, wherein the FIR-filter is adapted to precompensate the VCSEL-signal by adjusting a portion of the VCSEL-signal in the first bit after a signal transition, and wherein the precompensated VCSEL-signal is injected into a VCSEL.

This solution is particularly advantageous because it has been seen that resonances of the VCSEL can be cancelled out very efficiently by adjusting a portion of the VCSEL-signal in the first bit after a signal transition. While it is generally desirable to have a signal transmission that is as fast as possible, it turns out that applying such precompensation to a VCSEL-signal that is to be communicated via a VCSEL may cause delays. However, advantageously the signal quality can be improved significantly by suppressing a portion of the fast signal.

According to one preferred embodiment the adjusting comprises subtracting a portion of the VCSEL-signal in the first bit after a signal transition. The portion of the VCSEL-signal is subtracted so that the amplitude of the VCSEL-signal in the first bit after a signal transition is reduced. Thus, the precompensated VCSEL-signal has a different amplitude in the first bit after a signal transition as compared to the original (non-precompensated) VCSEL-signal.

In another preferred embodiment the adjusting comprises generating a delayed signal out of the VCSEL-signal, and adding the delayed signal to the VCSEL-signal. As a result of the addition, the amplitude of the VCSEL-signal is reduced in the first bit after a signal transition. Thus, the precompensated VCSEL-signal has a different amplitude in the first bit after a signal transition as compared to the original (non-precompensated) VCSEL-signal.

The advantages of the present application particularly apply to asymmetric, non-linear VCSEL-signals. As a result, the shape of the eye diagram can be improved and the VCSEL-signal avoids areas that are excluded by eye masks. This results in an improved data transmission, less misidentified bits of the signal and therefore allows for increased bandwidth as compared to known precompensation techniques.

It is further preferred that the VCSEL-signal is adjusted for essentially the duration of the first bit. This allows for an even more improved precompensation of the VCSEL-signal.

In a preferred embodiment the apparatus further comprises a VCSEL into which the precompensated VCSEL-signal is injected. As briefly noted above, vertical-cavity surface-emitting lasers (VCSELs) use a type of semiconductor laser diodes wherein the laser beam is emitted perpendicular to the top surface from the top surface of the laser diode as opposed to conventional edge-emitting semiconductor lasers. For instance, the VCSEL may emit light at 850 nm.

In another preferred embodiment the bandwidth of the VCSEL is in the range of 14 to 17 GHz. Such bandwidths are known to be very reliable with available VCSELs. However, it is also conceivable to have higher bandwidths. As another example, for data rates of 25 Gbps a bandwidth of 20-25 GHz may be used. For data rates of 10 Gbps the VCSELs have a bandwidth of at least 8 GHz. Higher data rates which may be used with all embodiments of the present disclosure could be 32 Gbps, 50 Gbps, or 56 Gbps. Generally, the described embodiments are preferred when the laser bandwidth falls roughly below 1.4× fundamental signal frequency. (e.g., for 25 Gbps the fundamental signal frequency is 12.5 GHz).

According to another preferred embodiment, the apparatus is implemented into an integrated circuit. This is advantageous because it enables a more practical implementation of the apparatus. The respective parts can easily be produced and interconnected.

It is another preferred embodiment that the integrated circuit of the apparatus comprises a delay element for causing a delay of the signal. As example, the delay element can be a transmission line, a buffer or a chain of buffers, or a clocked gate such as a flip-flop. The purpose of the delay element is to introduce a delay of the signal by one period of the VSCEL-signal.

According to a preferred embodiment, the integrated circuit comprises a series connection of at least two amplifiers for causing a delay of the signal.

In another preferred embodiment, the integrated circuit comprises a clock and at least one flip-flop or other clocked gate for causing a delay of the signal. In one example, this requires a clock that is synchronous to the data. As example, the clock can be send in parallel to the data or it can be extracted from the data stream through a clock data recovery circuit. This allows a precise delay by one data period, i.e., to apply the adjustment precisely in the first bit after a signal transition.

It is another preferred embodiment that the precompensation is only applied to a rising pulse edge (i.e., to the first bit after a signal transition on a rising edge). Extensive research has shown that applying the precompensation only to the rising pulse edge significantly improves the shape of the eye. This implementation is particularly advantageous since it reduces the overshoot and ringing on the rising edges, but does not slow down the signal on the falling edges.

In a preferred embodiment, the precompensated VCSEL-signal is adjusted by 20% to 30% in the first hit after a signal transition before it is injected into the VCSEL. Extensive research has shown that for many VCSELs such signal adjustment results in an optimized eye contour. This will be described in more detail with respect to the figures.

It is also preferred that the present disclosure can be realized by a method for precompensating a VCSEL-signal according to any of the embodiments described herein.

Moreover, all embodiments of the present disclosure may at least partially be implemented in a computer program comprising instructions for performing any of the embodiments described herein.

### BRIEF DESCRIPTION OF THE DRAWINGS

In the following, aspects of the present disclosure are discussed with respect to the accompanying figures. In detail:

FIG. 1 illustrates a symmetric eye diagram which is based on a linear model, wherein the signal shows several distortions;

FIG. 2 illustrates a measured eye diagram, wherein an eye mask has been added;

FIG. 3 illustrates a precompensation by adding a negative signal at the rising edge of a signal;

FIG. 4 illustrates a precompensation by adding a short positive signal at the rising edge of a signal;

FIG. 5a illustrates an exemplary signal shape for a VCSEL-signal and for a delayed signal in accordance with an embodiment of the present disclosure;

FIG. 5b illustrates an exemplary precompensation in accordance with an embodiment of the present disclosure;

FIG. 5c illustrates an exemplary precompensation in accordance with an embodiment of the present disclosure;

FIG. 6 illustrates a precompensation by adjusting the first bit after a transition of a signal;

FIG. 7a illustrates an integrated circuit for implementing one embodiment where the delay of one signal is achieved by a transmission line;

FIG. 7b illustrates an integrated circuit for implementing one embodiment where the delay of one signal is achieved by a buffer or chain of buffers;

FIG. 7c illustrates an integrated circuit for implementing one embodiment where the delay of one signal is achieved by a clocked gate;

FIG. 7d illustrates an integrated circuit for implementing one embodiment where the delay of one signal is achieved by a transmission line and where the precompensation signal is only applied after a rising edge;

FIG. 7e illustrates a circuit diagram for implementing one embodiment of the present disclosure;

FIG. 7f illustrates an embodiment of the present disclosure comprising a 3 tap filter;

FIG. 8 illustrates the frequency response of a symmetric 2 tap FIR filter.

FIG. 9 illustrates the frequency response of a symmetric 3 tap FIR filter.

FIG. 10 illustrates an eye diagram for a symmetric signal, and the corresponding precompensation and output voltage according to an embodiment of the present disclosure;

FIG. 11 illustrates an eye diagram for a symmetric signal, and the corresponding precompensation and output voltage according to an embodiment of the present disclosure;

FIG. 12 illustrates an eye diagram for a symmetric signal, and the corresponding precompensation and output voltage according to an embodiment of the present disclosure;

FIG. 13 illustrates an eye diagram for a symmetric signal, and the corresponding precompensation and output voltage according to an embodiment of the present disclosure;

FIG. 14 illustrates an eye diagram for a symmetric signal, and the corresponding precompensation and output voltage according to an embodiment of the present disclosure;

FIG. 15 illustrates an eye diagram for a symmetric signal, and the corresponding precompensation and output voltage according to an embodiment of the present disclosure;

FIG. 16 illustrates an eye diagram for a symmetric signal, and the corresponding precompensation and output voltage according to an embodiment of the present disclosure;

FIG. 17 illustrates an eye diagram for an asymmetric signal according to an embodiment of the present disclosure; and

FIG. 18 illustrates a precompensated signal and a resulting eye diagram according to an embodiment of the present disclosure.

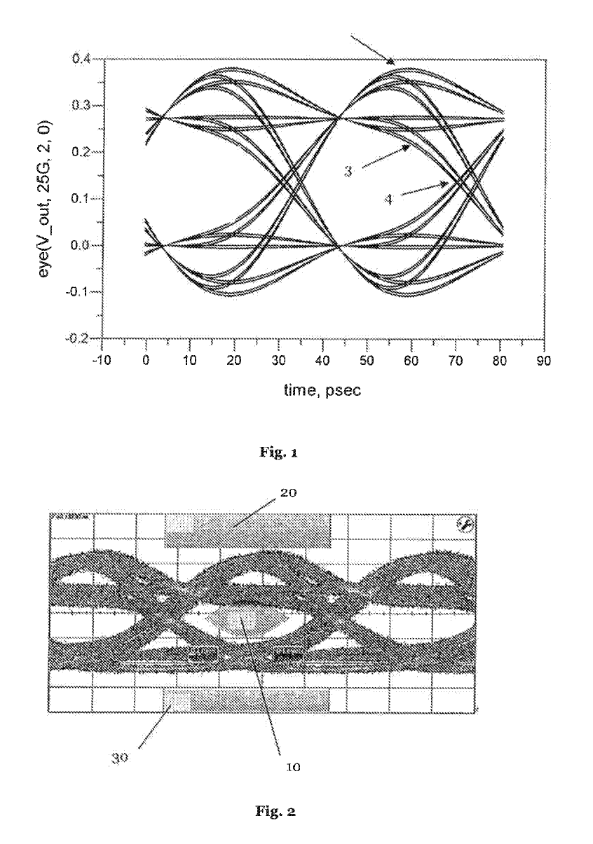

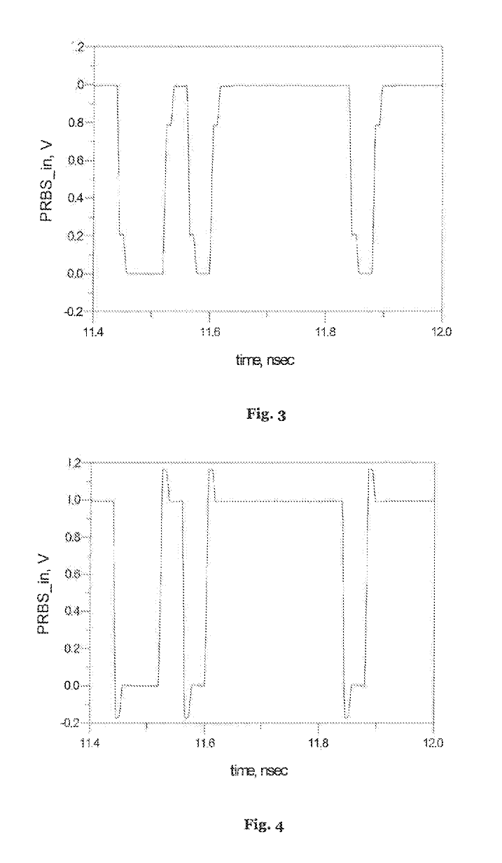

### DETAILED DESCRIPTION

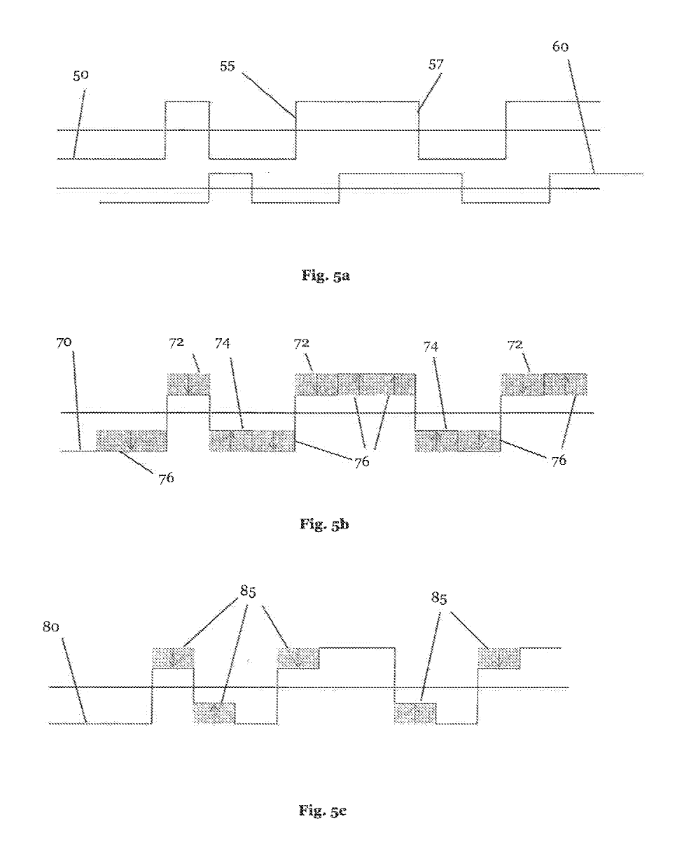

FIG. 5a illustrates two embodiments for adjusting the VCSEL-signal (50) in the first bit after a signal transition. Shown transitions occur on rising edges (55), e.g., from 0 to 1, and on falling edges (57), e.g., from 1 to 0. According to one embodiment, the adjusting of the signal comprises subtracting or adding a portion of the VCSEL-signal in the first bit after a signal transition. It is noted that the adjusting may be applied only to the first bit after signal transitions on rising edges (55) or only to the first bit after signal transitions on falling edges (57), or to both, transitions on rising edges (55) and transitions on falling edges (57). In one embodiment, adjustments may additionally be applied to other bits than only the first bit after a transition. Applying the precompensation by adjusting a portion of the VCSEL-signal may require delaying the VCSEL-signal. In one example the signal may be delayed by 1 bit or multiples thereof). In other words, the delayed signal corresponds to the VCSEL-signal, however it is delayed by a specific duration. The delaying of the VCSEL-signal may be achieved by several means which are discussed in further detail below. In FIG. 5a, the delayed signal is depicted by the curve (60). The amplitude of the delayed signal may be reduced by a factor as compared to the amplitude of the VCSEL-signal. This factor depends on various criteria, such as the hardware components or the VCSEL-type. This factor may also be referred to as de-emphasis (or pre-emphasis) and will be explained in further detail below.

The delayed signal (60) is then added to the VCSEL-signal (50), resulting in the precompensated VCSEL-signal exemplarily shown by curve (70) in FIG. 5b. As can be seen, this addition leads to a decreased amplitude of the precompensated signal in the first bit after a signal transition. In the example of FIG. 5b the result in the first bit after a signal transition is indicated by the reference numerals (72) for adjustments in the first bit after rising edges and (74) for adjustments in the first bit after falling edges. In the example shown in FIG. 5b, the addition also leads to an adjustment of bits other than the first bit after a transition (e.g., the second and the third bits). In FIG. 5b these bits are designated by reference numerals (76). However, it is sufficient to only adjust the first bit after a transition. Adjusting the other bits is not required for improving the precompensation.

In another embodiment illustrated by FIG. 5c, the VCSEL-signal (80) is precompensated by subtracting a portion of the VCSEL-signal in the first bit after a signal transition. In FIG. 5c these bits are designated by the reference numerals (85). It is noted, that depending on the specific implementation, it may also be necessary to generate a delayed signal for the embodiment wherein the precompensation is carried out by subtracting a portion of the VCSEL-signal in the first bit after a signal transition. Methods and apparatuses for generating a delayed signal are described below.

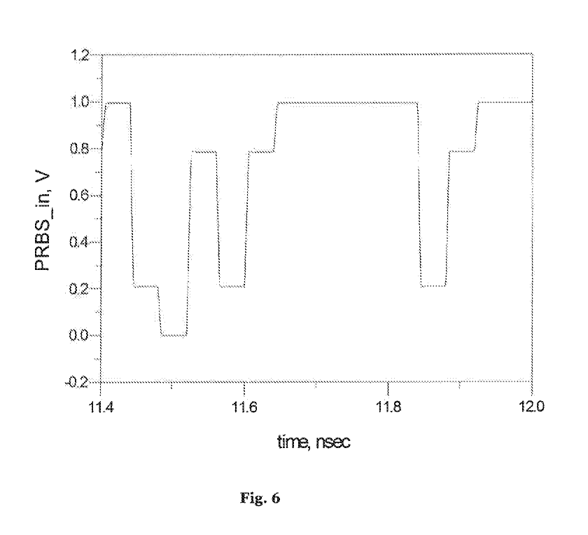

FIG. 6 illustrates the precompensation according to an embodiment of the present disclosure. In more detail, a VCSEL-signal is adjusted by subtracting the first bit after a transition of the signal value from 0 to 1 or from 1 to 0. This is done so that the amplitude of the signal (in FIG. 6 indicated in Volts) is reduced.

However, it is also conceivable to adjust the VCSEL-signal by adding the delayed signal (with one 1 bit delay) to the initial VCSEL-signal in the first bit after the signal transition. This would lead to the same result. It is noted that all embodiments discussed herein work with adjustments wherein the amplitude of the delayed signal is increased or decreased in the first hit after the signal transition. As can be seen from FIG. 6, in this embodiment the precompensation is applied by adjusting the voltage of the DC signal in the first bit after the transition by a specified amount. This may be achieved by a compensation signal. It is noted that the sign of the compensation signal may have to be varied depending on whether it is applied to a signal in the first bit after a signal transition on the rising edge or to a signal in the first bit after a signal transition on the falling edge. The specific amount by which the DC signal is adjusted in the first bit after the transition depends on several factors. For instance, the amount depends on the hardware, e.g., it is specific to the VCSEL. This so-called pre- or de-emphasis is usually specified in relative terms, i.e., percent or dB (e.g., of the maximum signal). But it can also be specified in absolute terms as a voltage or current. To illustrate this, for driving the VCSEL, one could also specify a de-emphasis current, say 2 mA. For a laser current of 10 mA this would be 20%, or in the terminology used herein this would be referred to as DE=0.2.

For other VCSELs or other hardware configurations, the adjustment of the VCSEL-signal may be 5% (DE=0.05), 10% (DE×0.10), 15% (DE=0.15), 25% (DE=0.25), 30% (DE=0.35), 35% (DE=0.35), or any other percentage. In any case, the required adjustment of the signal in the first bit after the transition has to be determined for each specific hardware combination. The adjustment of the VCSEL-signal is determined so that the resonances of the signal are reduced.

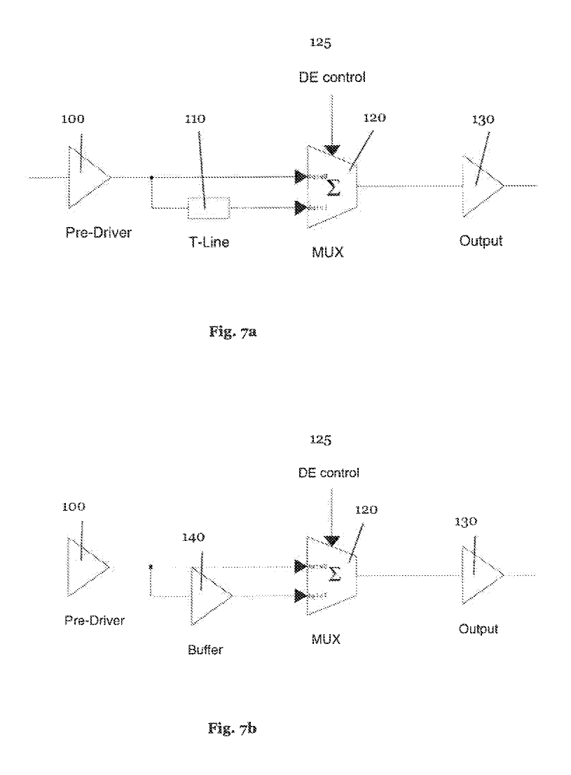

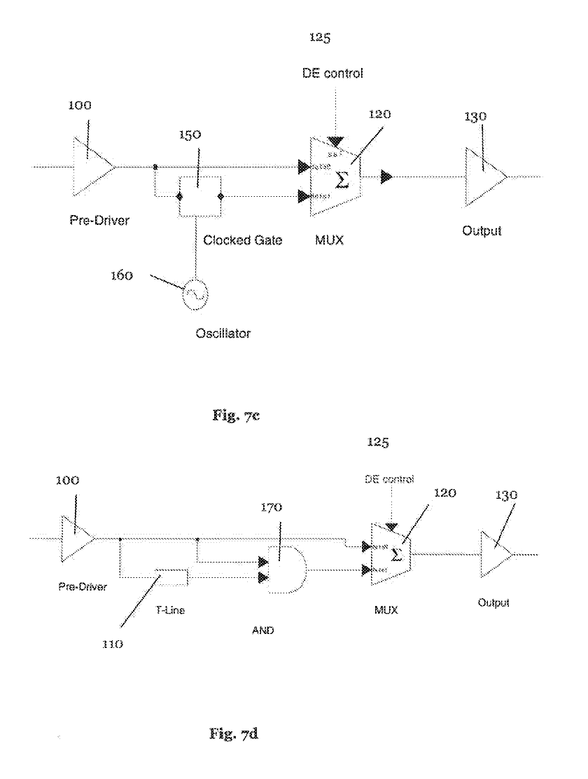

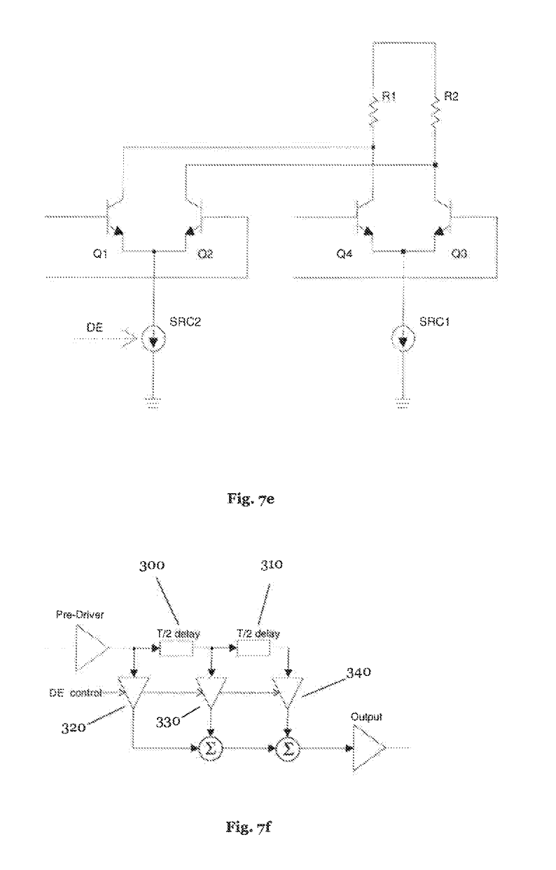

FIGS. 7a to f illustrate possible implementations of the apparatus according to several embodiments of the present disclosure.

FIG. 7a shows an embodiment where part of the VCSEL-signal is delayed by a transmission line (110), herein also referred to as T-Line. After a pre-driver (100) the VCSEL-signal is split with part of the signal going through the transmission line (110). The delayed signal out of the transmission line (110) and the non-delayed signal are combined in an analog multiplexer (120) or mixer (herein also referred to as MUX). The mixing of the two signals is controlled by a control pin (125) labeled “DE control”. The combined signal is then amplified by a linear output stage (130) that preserves the precompensated signal shape.

FIG. 7b shows an embodiment where part of the VCSEL-signal is delayed by a delay buffer (140) or a chain of delay buffers. After a pre-driver (100) the VCSEL-signal is split with part of the signal going through the delay buffer (140). The delayed signal out of the delay buffer (140) and the non-delayed signal are combined in an analog multiplexer (120) or mixer. The mixing of the two signals is controlled by a control pin (125) labeled “DE control”. The combined signal is then amplified by a linear output stage (130) that preserves the precompensated signal shape.

FIG. 7c shows an embodiment where part of the VCSEL-signal is delayed by a clocked gate (150). After a pre-driver (100) the VCSEL-signal is split with part of the signal going through the clocked gate (150). The clocked gate may be controlled by an oscillator (160). The delayed signal out of the clocked gate (150) and the non-delayed signal are combined in an analog multiplexer (120) or mixer. The mixing of the two signals is controlled by a control pin (125) labeled “DE control”. The combined signal is then amplified by a linear output stage (130) that preserves the precompensated signal shape.

FIG. 7d shows one embodiment of a differential mixer (170). After a pre-driver (100) the VCSEL-signal is split with part of the signal going through the transmission line (110). The signal of the T-Line (110) is then AND combined in logic circuit (170) with the non-delayed signal of the pre-driver (100). The differential mixer (120) comprises two differential current mode logic stages. The signal of the two stages is added in the termination resistors. In the illustrated embodiment the current of the stage with the de-emphasis signal is external controlled by controlling the current source by using a control pin (125) labeled “DE control” (125). The combined signal is then amplified by a linear output stage (130) that preserves the precompensated signal shape.

FIG. 7e shows one embodiment of mixer based on current-mode-logic (CML), labeled as MUX in FIGS. 7a,b,c,d, and f. The mixing ratio can be varied controlling the current sources SRC2 and SRC1. Depending on the application, adding or subtracting of the mixed signal might be required. Both functions can be achieved depending on the polarity of the input signal connection.

FIG. 7f shows another embodiment of a possible setup. The illustrated setup implements a 3 tap filter, wherein the first delay element (300) generates a signal that is delayed by T/2, and wherein the second delay element (310) generates a signal that is delayed by another T/2 (which then results in a delay of T). The precompensation is applied by the DE control pins 320, 330, and 340 as described herein. These DE control pins can be controlled separately, and each may apply a different precompensation, as discussed herein in more detail. The precompensated output current is the combination of the three signals, and this precompensated signal may then be injected into the VCSEL.

Preferably, one or more FIR-filters are used for achieving the desired precompensation of the VCSEL-signal. FIR filters are finite impulse response filters which have an impulse response of finite duration because it settles to zero in finite time. FIR filters are discrete filters and may be implemented digitally. FIR filters have the advantage of being inherently stable.

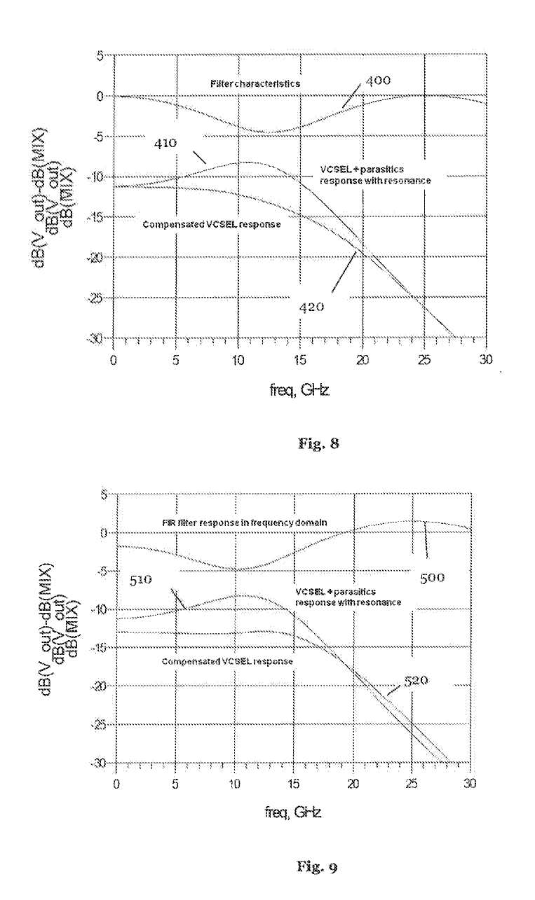

FIG. 8 shows the frequency response of the uncompensated VCSEL together with the connecting elements. The frequency response (410) exhibits a resonance at 12 GHZ and a 3 dB bandwidth of 18 GHz. The top of the graph (400) shows the frequency response of an FIR filter with one tap and a delay of T as shown in FIGS. 7a to 7e. The bottom curve (420) shows the result of the optimized compensation with the elimination of the resonance. The 3 dB bandwidth is reduced to 15 GHz, but due to the lack of resonance the optical eye is improved.

FIG. 9 shows a possibility to eliminate (510) the resonance (520) while maintaining or even increasing the bandwidth of the system. Here (500) a 2-tap filter is used, comprising one delay of T and one delay of T/2.

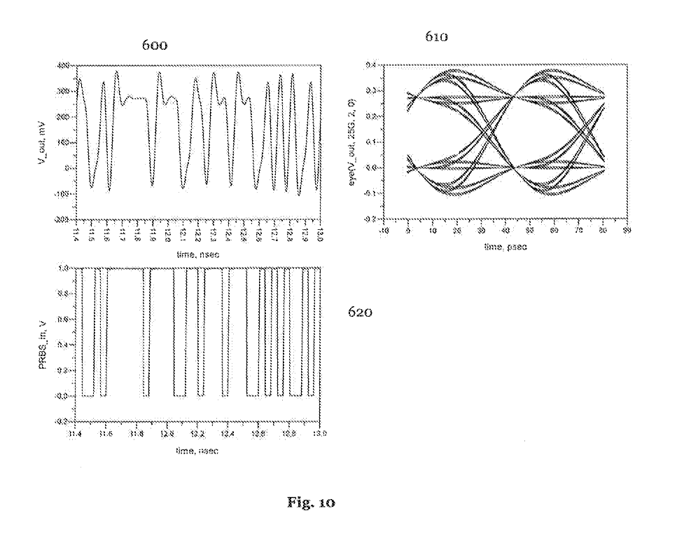

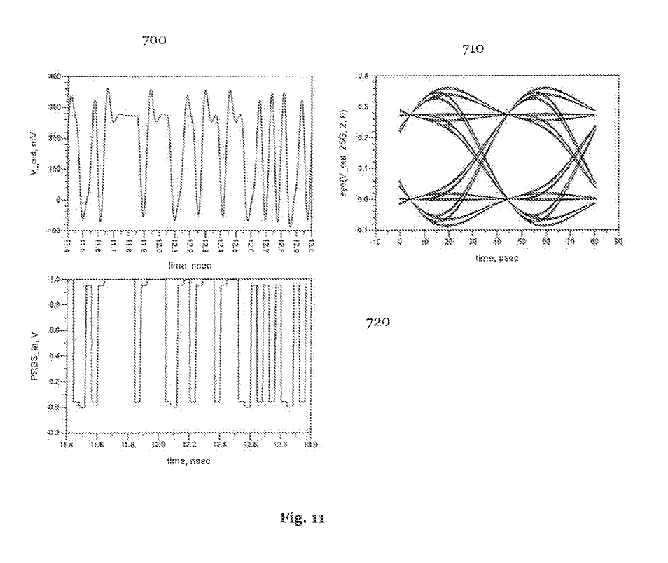

FIGS. 10 to 16 show eye diagrams (in the upper right corner, respectively) which result from precompensations of the signal with different values. For illustrative purposes, FIGS. 10 to 16 show results for a symmetric model. However, as will be explained and illustrated later, the same results are valid for asymmetric, non-linear models.

As an example, FIG. 10 shows the eye diagram (610) wherein no precompensation has been applied. In other words, the VCSEL-signal in the first bit after a transition is not adjusted (i.e., no portion of the signal is decreased or added). This can also be seen in the bottom left diagram (620) of FIG. 10, wherein the VCSEL-signal oscillates between 0 Volt and 1 Volt. The top left diagram (600) of FIG. 10 illustrates the output signal of the VCSEL.

Subsequent FIGS. 11 to 16 are based on the same model. However, the respective precompensation is different. For FIG. 11, the precompensation is applied by adding a compensation signal in the first bit after the transition. The precompensation corresponds to a DE value of 4%. This can be seen in the bottom left diagram (720) of FIG. 11, wherein the signal in the first bit after a transition is decreased. The corresponding output signal is shown in the top left diagram (700) of FIG. 11. The effect on the eye diagram is illustrated in diagram (710).

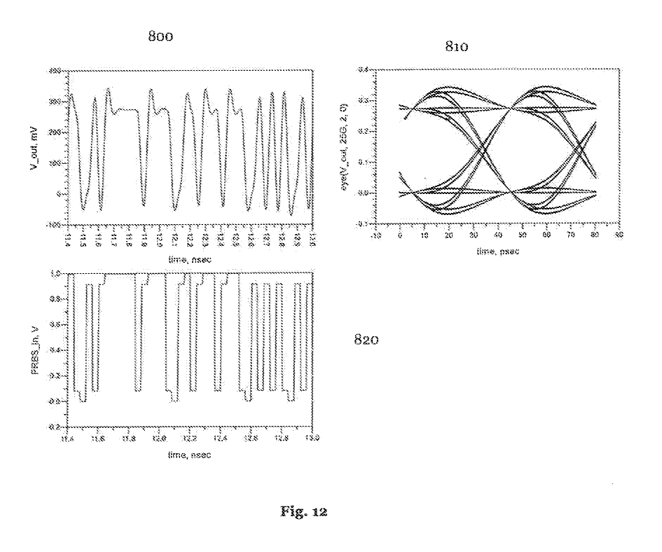

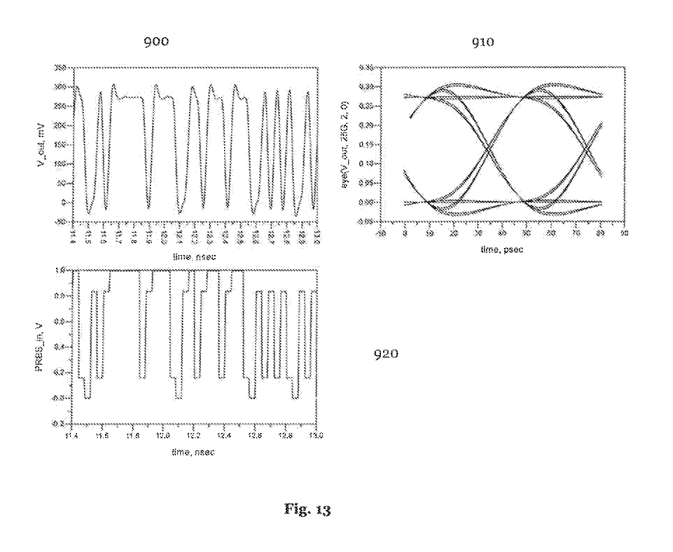

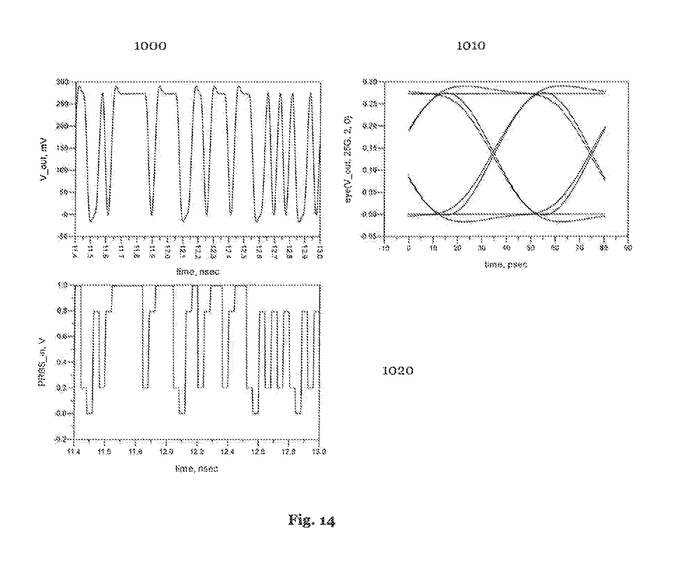

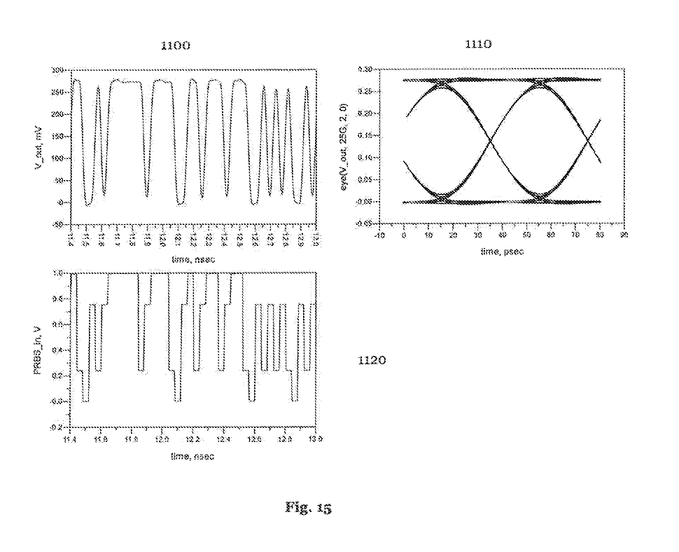

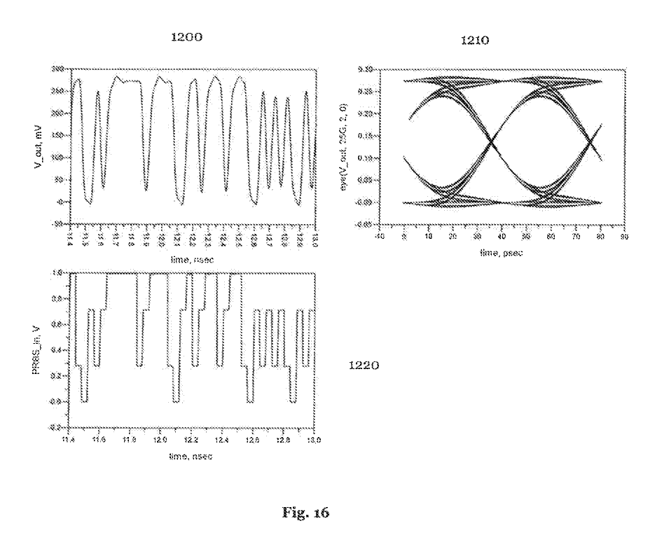

In FIG. 12, the precompensation is applied by adding a compensation signal in the first bit after the transition. The precompensation corresponds to 8%. Again, this can be seen in the bottom left diagram (820) of FIG. 12, while the resulting output voltage is shown in the top left diagram (800) and the eye diagram in the top right diagram (810). While FIGS. 13 to 16 show the same diagrams for different precompensation values (FIG. 13: 16%; FIG. 14: 20%; FIG. 15: 24%; FIG. 16: 28%) illustrated in the bottom left diagrams (920, 1020, 1120, 1220) and corresponding output voltages (900, 1000, 1100, 1200), it becomes clear from comparing the respective eye diagrams (910, 1010, 1110, 1210) that the shape of the eye diagrams improves. This means that the interferences and distortions, e.g., caused by resonances in the VCSEL, may be reduced. As a result, the signal quality improves and allows for a data transmission so that the precompensated VCSEL-signal does not overlap with the areas excluded by an eye mask. For the precompensation values shown in FIGS. 14, 15, and 16, the resonances can be greatly decreased, thus giving less interference and enabling a better transmission of the signal from the transmitter via fiber optics to the receiver.

While it is clear to the skilled person that there may be different definitions of eye masks (e.g., depending on a certain standard), it is also clear that a small portion of the signal may still fall into the excluded areas of the eye mask. However, such false signals may occur only rarely and due to statistical fluctuations do not significantly influence the precompensated VCSEL-signal.

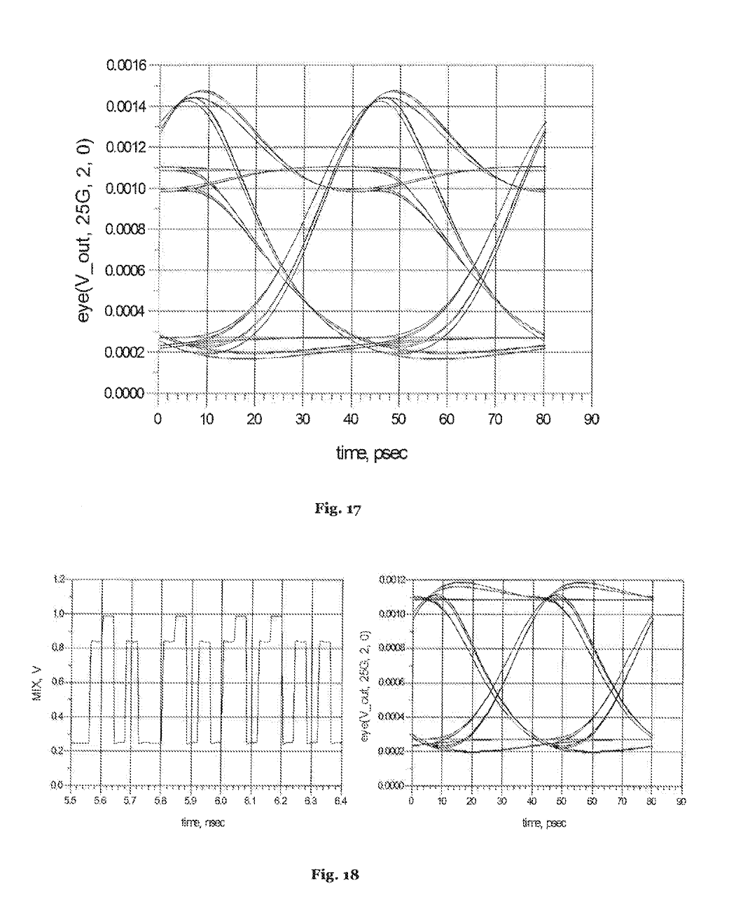

FIG. 17 shows an eye mask for an asymmetric signal. The negative effects, i.e., the overshooting curves distorting the signal which make the correct reconstruction more difficult can clearly be seen. No precompensation has been applied to the signal of FIG. 17.

FIG. 18 shows the signal of FIG. 17, wherein the VCSEL-signal has been precompensated according to an embodiment of the present disclosure. The left diagram of FIG. 18 illustrates the decreased signal in the first bit after a transition, wherein the precompensation is only applied to the rising edge. The precompensation is only applied to the VCSEL in “ON” state when a logic high current is applied. The right diagram shows the corresponding eye diagram with greatly improved eye shape. The signal quality and the reconstruction of the signal are thereby greatly improved. In particular it can be seen in FIG. 18 that the precompensation avoids that the DC level is moved upwards which would decrease the sensitivity of receiver circuits models. It is noted that FIG. 18 illustrates a precompensation only for the rising edge. A similar effect can be reached by applying the precompensation to both, rising and falling edges of the signal. However, applying the signal to the falling edge may slow down the signal, which could make the signal worse.

1. Apparatus for precompensating a VCSEL-signal, comprising:
a FIR-filter adapted to precompensate a signal by adjusting a portion of the signal in the first bit after a signal transition,
wherein the precompensated signal is injected into a VCSEL.

2. Apparatus according to claim 1, wherein the adjusting of a portion of the signal in the first bit after a signal transition comprises adding a positive or negative compensation signal.

3. Apparatus according to claim 2, further comprising a VCSEL, into which the precompensated signal is injected.

4. Apparatus according to claim 1, wherein the bandwidth of the VCSEL is in the range of 14 to 17 GHz.

5. Apparatus according to claim 1, wherein the apparatus is implemented into an integrated circuit.

6. Apparatus according to claim 5, wherein the integrated circuit comprises a delay element.

7. Apparatus according to claim 6, wherein the delay element comprises a transmission line for causing a delay of the signal.

8. Apparatus according to claim 5, wherein the integrated circuit comprises a series connection of at least two amplifiers for causing a delay of the signal.

9. Apparatus according to claim 5, wherein the integrated circuit comprises a clock and at least one flip-flop for causing a delay of the signal.

10. Apparatus according to claim 1, wherein the precompensation is only applied to a rising pulse edge.

11. Apparatus according to claim 1, wherein the precompensation is only applied to a falling pulse edge.

12. Apparatus according to claim 11, wherein the input signal to the VCSEL in the first bit after a signal transition is adjusted by 20% to 30%.

13. Method for precompensating a VCSEL-signal, the method comprising:
adjusting a portion of the signal in the first bit after a signal transition with a FIR-filter adapted to precompensate the signal, and
injecting the precompensated signal into a VCSEL.

14. A non-transitory computer program comprising instructions for performing a method, comprising:
adjusting a portion of the signal in the first bit after a signal transition with a FIR-filter adapted to precompensate the signal, and
injecting the precompensated signal into a VCSEL.
